(19) United States
(12) Patent Application Publication
(10) Pub. No.: US 2010/0269617 A1
(43) Pub. Date: Oct. 28, 2010

(54) METHOD OF PRODUCING A POLYMER COATING

(75) Inventor: Guenter Eitzinger, Timelkam (AT)

Correspondence Address: COLLARD & ROE, P.C., 1077 NORTHERN BOULEVARD, ROSLYN, NY, 11576, US

(73) Assignee: High Tech Coatings GmbH, Laakirchen (AT)

(21) Appl. No.: 12/735,016

(22) PCT Filed: Dec. 15, 2008
(86) PCT No.: PCT/AT2008/000451

§ 371 Date: Jun. 9, 2010

(30) Foreign Application Priority Data
Dec. 14, 2007 (AT) A 2041/2007

(51) Int. Cl. F16H 55/06; B05D 3/04

(52) U.S. Cl. 74/457; 427/539

(57) ABSTRACT

The invention relates to a method of producing an abradable polymer coating (5), optionally containing at least one solid lubricant, on a surface of teeth (7, 8) of a metal toothed element (1, 2) for setting a tooth flank clearance (4) between the teeth (7, 8) of two meshing toothed elements (7, 8), whereby the abradable polymer coating (5) is applied to at least part of a surface of the teeth (7) of at least one toothed element (7, 8). Prior to applying the polymer coating (5), the surface to be coated is treated in a plasma and the polymer coating (5) is then applied directly to this surface.

The invention relates to a method of producing an abradable coating on a surface of teeth or a toothed element for setting a tooth flank clearance between teeth of two meshing, metal toothed elements, whereby the abradable polymer coating is applied to at least part of a surface of the teeth of at least one toothed element, a metal toothed element with a main body with teeth along its circumference which have an abradable polymer coating on at least part of a surface, as well as a drive with at least two meshing toothed elements.

The reasons why a specific tooth flank clearance is set between gears, for example of a drive, are to enable a lubricant film to form, to compensate for dimensional changes caused by the effects of temperature, to compensate for tooth deformation caused by stress and to compensate for manufacturing and assembly errors, as described in patent specification DE 199 55 474 C1. In addition, however, a specific tooth flank clearance must be maintained in order to minimise the noise emitted by such drives.

In addition to setting the tooth flank clearance on the basis of purely mechanical methods using gauges for example, another option which has been described is that of providing an intermediate layer or abradable coatings for this purpose.

For example, patent specification DE 199 55 474 C describes a method of setting a tooth flank clearance in a gear drive, in particular for balancing shafts of internal combustion engines, whereby at least a first gear rotatable about an axis which is fixed with respect to the housing is provided and during assembly, involving the setting of a tooth flank clearance, a second gear is moved towards it axially parallel in a sliding action, and in order to set the tooth flank clearance, a removable intermediate layer is used which is disposed between the tooth flanks of mutually engaging teeth of the meshing gears. This intermediate layer is provided in the form of a layer which is fixed so that it covers the tooth flanks of specific teeth of at last one of the gears before it is assembled, and the gear with the fixed layer or intermediate layer disposed on it is moved into a clearance-free engagement with co-operating tooth flanks of the other gear with a predefined force during assembly, and once the tooth flank clearance of the gears has been adjusted due to abrasion of the layer during running or when a specific mechanical seating has been achieved, the intermediate layer is removed. The layer might be a solid lubricant or a one applied by galvanic deposition. There have also been disclosures of intermediate layers in the form of moulded parts made from plastic or an elastomer or metal film or wire mesh.

Patent specification WO 02/48575 A describes a method of obtaining a desired tooth flank clearance in a gearing with at least two meshing gears which are set relative to one another by means of a removable coating on at least one of the gears in order to adjust the clearance. The coating contains a mixture of polymer material and a solid lubricant.

Patent specification DE 10 2005 013 867 A also describes a method of setting a circumferential backlash of mutually meshing toothed partners by means of a detachable coating, which is applied in the space between the teeth of the toothed partners for which a mutual clearance has to be set in a coating thickness largely corresponding to the specified circumferential backlash, and the coating contains a mixture of 5% by weight to 20% by weight of polymer material, 5% by weight to 20% by weight of solid lubricant and up to approximately 75% by weight of solvent.

It is known from practical experience that in the past, in order obtain sufficient adhesive strength, these coatings could only be applied with the aid of coatings of primer. In both patent specification WO 02/48 575 A and patent specification DE 10 2005 013 867 A, coatings are always applied to phosphatised gears in the embodiments described as examples. This phosphatisation imparts a higher surface roughness to the surface to be coated, thereby resulting in a better bond between the tooth surface and coating when it comes to setting the tooth flank clearance.

The objective of this invention is to propose a possible way of implementing a method for setting a tooth flank clearance more cost-effectively.

This objective is achieved by the invention due to the above-mentioned method of producing an abradable coating whereby the surface to be coated is treated in a plasma prior to applying the coating and the coating is then applied directly to this surface—without having to use primers such as phosphatising coats—and independently of this, is also achieved by means of a metal toothed element, to the metal surface of which the polymer coating is applied directly, and a corresponding drive incorporating at least one toothed element of the type proposed by the invention.

Whereas conventional coating methods used for this purpose involve alkaline degreasing of the surface, followed by pickling, applying a coat of manganese phosphates, drying the latter and then brushing it off, the method proposed by the invention significantly reduces this sequence of individual method steps because all that is necessary is activation of the surface by the plasma. This enables the cycle times needed to coat toothed elements of this type to be reduced and hence also the costs used to manufacture them. Furthermore, no waste water is generated, thereby making this process more environmentally friendly. The fact that aqueous solutions, such as alkaline solutions, are avoided also makes it easier to deal with problems of corrosion. Obviating the need for an additional coat of primer also reduces coating costs. Activation by means of plasma results in a very good bonding quality of the applied coating, which also enables the amount of waste to be reduced. Generally speaking, this method is technically easy to implement and lends itself more readily to automation. In addition to a better adhesion capacity, the applied coating also exhibits greater homogeneity. High process stability also makes process control easy. Increasing the surface tension of the metal surface simultaneously also increases the difference between the surface tension and the surface tension of the coating and hence also the wettability of the metal surface, thereby improving the adhesion strength of the coating. Eliminating the phosphatisation process and the associated increase in surface roughness created by this phosphatisation means that it is possible to make the coating within narrower coating thickness tolerances, which is always described as being a problem in the prior art because the positioning of the second toothed element is inexact.

For the sake of completeness, it should be pointed out that the term plasma should be understood as meaning a partially ionised gas.

Although it is possible to use both oxidising and reducing plasmas within the context of the invention, an oxygen plasma is used by preference. This is primarily because oils such as cutting oils or similar are very often adhered to the metal surfaces to be coated, left behind from previous processes during manufacture of the toothed elements. Using an oxygen plasma also enables the surface to be cleaned at the same time and the toothed element can be placed on the cathode or connected as a cathode, and a microwave plasma is preferably used so that excited oxygen or oxygen ions are accelerated towards the surfaces of the toothed element. The ions therefore detach atoms or molecules from the surface due to the direct pulse transmission and carbon dioxide and water are formed from these hydrocarbon fragments.

By oxygen plasmas within the meaning of the invention is meant a plasma with an oxygen content. It may also contain other gases, such as argon, for example. The proportion of oxygen in this gas mixture is preferably selected from a range with a lower limit of 40% by volume and an upper limit of 100% by volume, in particular selected from a range with a lower limit of 80% by volume and an upper limit of 100% by volume.

Other advantages are the high degree of cleaning obtained at the surface, for example a high degree of degreasing, and the process stability mentioned above. Moreover, after this surface treatment, drying is not necessary.

During the course of developing the invention, it was found to be of advantage if the plasma treatment is conducted at a temperature selected from a range with a lower limit of 40° C. and an upper limit of 100° C. At temperatures of below 40° C., the cleaning action of the plasma was unsatisfactory and it was only possible to clean the surface if operating for a longer period of time. At temperatures above 150° C., it was found that undesired changes could occur in the pattern of the toothed element, which adversely affect the component characteristics, in particular the hardness of the surface.

In particular, this temperature for the plasma treatment is selected from a range with a lower limit of 45° C. and an upper limit of 90° C., preferably selected from a range with a lower limit of 50° C. and an upper limit of 80° C.

Furthermore, it has proved to be conducive to operate the plasma treatment at a pressure selected from a range with a lower limit of 0.1 mbar and an upper limit of 200 mbar. Although, in theory, it is also possible to use a plasma at atmospheric pressure within the context of the invention in conjunction with a low pressure plasma, the higher number of activated, accelerated gas ions or gas atoms in the treatment chamber causes a loss of energy due to these ions and atoms colliding with one another in the acceleration path between the anode and cathode.

In other words, some of the energy is lost in the form of impact energy between the atoms rather then being transmitted to the surface of the toothed element.

In particular, this pressure for the plasma treatment is selected from a range with a lower limit of 0.1 mbar and an upper limit of 10 mbar, preferably from a range with a lower limit of 0.2 mbar and an upper limit of 0.7 mbar.

In order to obtain a coating that is as homogeneous as possible with a narrow coating thickness tolerance, it is of advantage if the surface tension of the metal surface of the toothed element is increased by at least 10% compared with the surface tension prior to treatment and if the surface tension is at least 40 mN/m. In particular, the surface tension of the metal surface is increased by a value of at least 20%, preferably by a value of at least 30% and the surface tension is at least 50 mN/m, preferably at least 60 mN/m. This improves adhesion of the coating to the metal surface so that higher coating thicknesses of the coating can be achieved with only a single application.

In this respect, it is of advantage if the plasma treatment is conducted at an alternating voltage selected from a range with a lower limit of 10 kHz and an upper limit of 3 GHz. At alternating voltages of less than 10 kHz, activation of the surface of the toothed element was found to be significantly slower. Above 3 GHz, no further improvement to the method was observed, i.e. the plasma treatment.

In particular, the plasma treatment is conducted at an alternating voltage with a frequency selected from a range with a lower limit of 50 kHz and an upper limit of 100 MHz, preferably selected from a range with a lower limit of 100 kHz and an upper limit of 50 MHz, and the frequency of the alternating voltage is selected from a range with a lower limit of 0.5 GHz and an upper limit of 3 GHz, preferably from a range with a lower limit of 1.5 GHz and an upper limit of 2.5 GHz.

It is also possible for the surface to be coated to be put through at least a single cleaning process, preferably several cleaning processes, with at least one oil-dissolving cleaning agent prior to the treatment with plasma. This enables a higher degree of surface cleaning to be achieved and the cleaning effect of the plasma is improved by using oil-dissolving cleaning agents because cleaning agents of this type usually have a significantly shorter chain length in the structure than oily residues and can therefore be broken down in the plasma much more efficiently.

This cleaning process is preferably conducted partially under vacuum, as a result of which the oil-dissolving cleaning agent used evaporates at lower temperatures already and the evaporation also takes place much more quickly, and during evaporation, at least some of the oil residues on the metal surface are carried away by the solvent, i.e. cleaning agent. Depending on the desired degree of cleaning and the strength of the cleaning action of the oxygen plasma or oxidising plasma, this treatment can be run several times. For cleaning, the toothed elements—preferably several toothed elements are subjected to this treatment simultaneously—are placed with the cleaning agent in a chamber which can be evacuated and for example this chamber is vented with the cleaning agent, after which the cleaning agent is pumped out and any residues of the cleaning agent are removed by applying a vacuums so that the surface of the toothed element is dried again.

The cleaning agent used is preferably perchloroethylene because perchloroethylene has a very short molecule chain which can therefore be broken down very easily in the plasma and perchloroethylene also has a very low boiling point compared with other oil-dissolving cleaning agents. Due to the low boiling point, the process of removing it, i.e. drying the surface, can be run very easily and rapidly.

The method proposed by the invention advantageously also offers the possibility of producing these toothed elements as sintered components rather than components produced in the standard manner used to date by melting metal, i.e. it is possible to use toothed elements made from sintered materials which are known to have a certain residual porosity because the cleaning used, especially if applying a vacuum, has a stronger effect in terms of depth and the cleaning agent, in particular perchloroethylene, also cleans the pores of the sintered material, in particular removes grease from it, as it evaporates under vacuum. This makes it possible to coat toothed elements and set their tooth flank clearance based on a manufacturing process that is not only cheaper than using conventional metallurgy to produce toothed elements, there is also the advantage that they can be produced to a greater degree of accuracy in terms of the geometry of the toothing.

In this respect, it is of advantage if the toothed element has a main body which has a porosity, at least in regions close to the surface, selected from a range with a lower limit of 0.1% and an upper limit of 20% because this makes cleaning and activation much simpler and the drive on which it is fitted will have a better oil retaining capacity, making these drives more efficient, and the method proposed by the invention can also be used for toothed elements produced by sintering techniques with a view to setting their tooth flank clearance or circumferential angle.

To provide a clearer understanding of the invention, it will be described in more detail below with reference to the appended drawings.

The drawings provide highly schematic, simplified diagrams of the following:

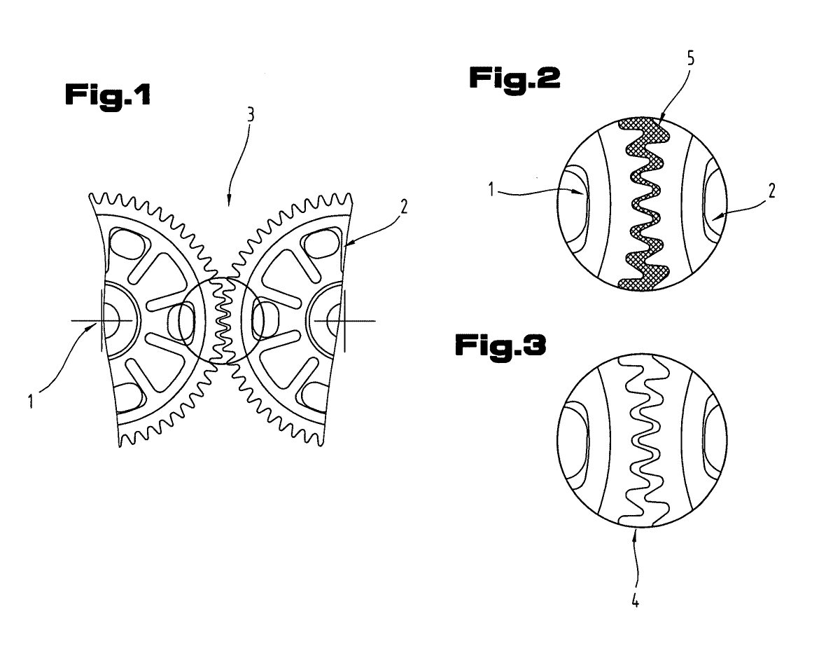

FIG. 1 a detail from a drive with two meshing gears;

FIG. 2 a detail of the two gears in the meshing region after assembling the gears;

FIG. 3 the detail illustrated in FIG. 2 but after running in;

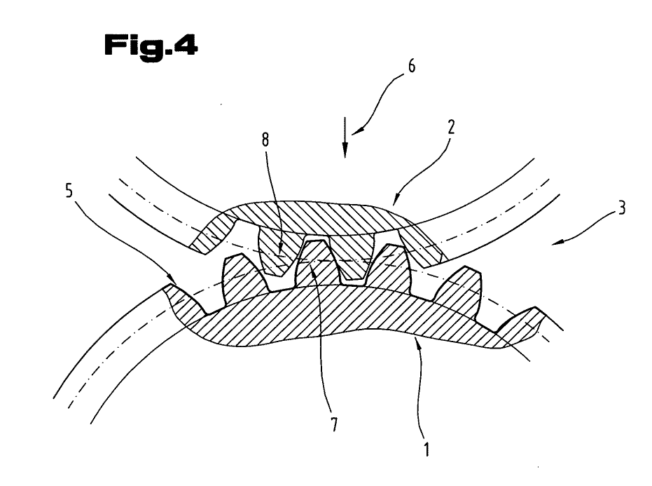

FIG. 4 a detail showing the process of setting the tooth flank clearance of two meshing gears;

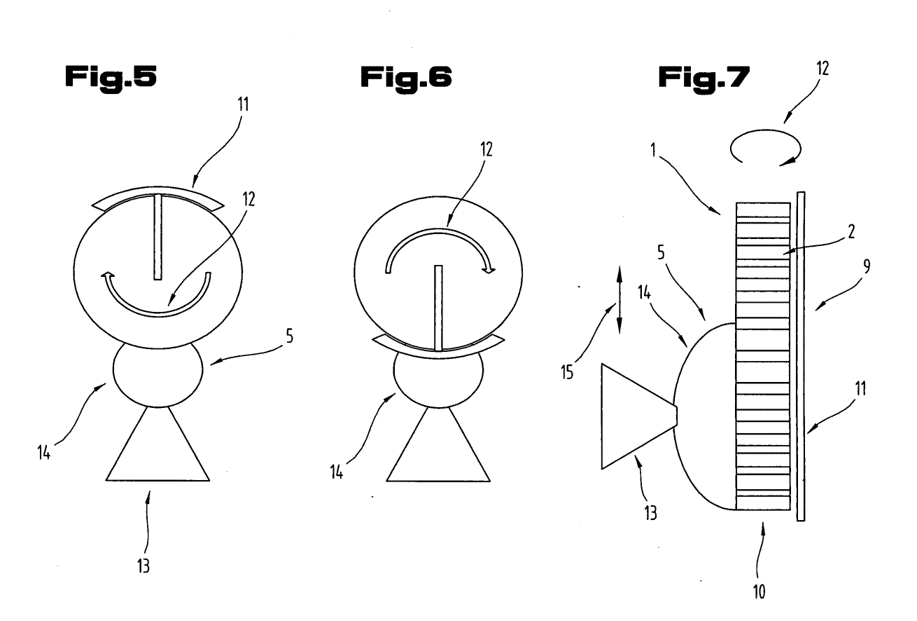

FIG. 5 a plan view of a coating device for partially coating toothed elements;

FIG. 6 the coating device illustrated in FIG. 6 with the toothed elements in a different angular position;

FIG. 7 a side view of the coating device illustrated in FIG. 6;

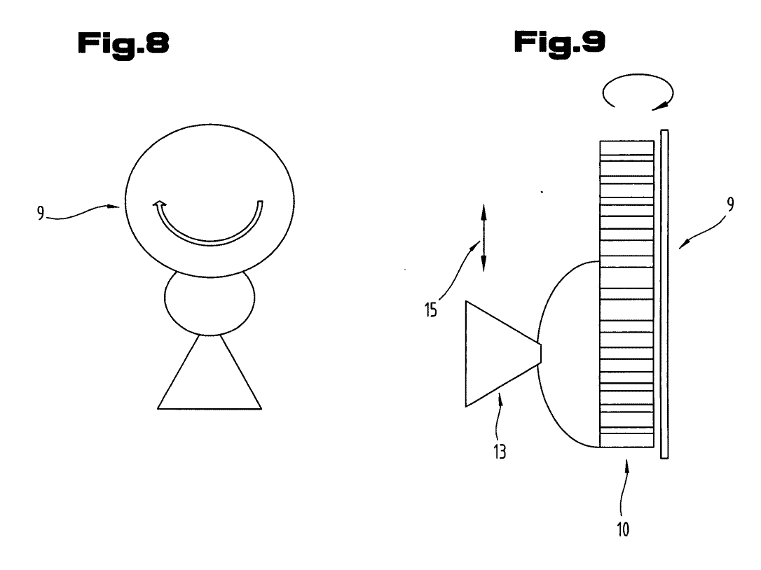

FIG. 8 a different embodiment of the coating device illustrated in FIG. 6;

FIG. 9 a side view of the coating device illustrated in FIG. 9;

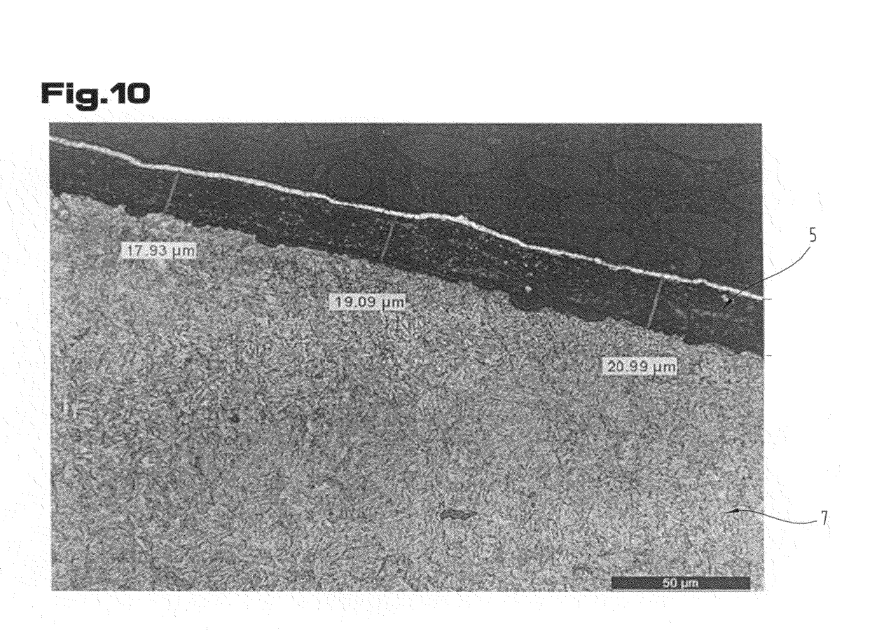

FIG. 10 a grinding pattern of a surface region of a coated tooth.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

FIG. 1 illustrates two toothed elements 1, 2 of a drive 3 in the region where these toothed elements 1, 2 mesh with one another. These toothed elements 1, 2 are gears of a spur gear. This might be a gear for balancing shafts used to balance weight. In principle, however, all drives with toothed elements 1, 2 fall within the scope of the invention, such as oil pump gears or similar, as well as toothed elements 1, 2 such as gears which engage in worm gears. Furthermore, these gears or toothed elements 1, 2 need not necessarily have straight toothing as illustrated in FIG. 1 and instead they may also have inclined toothing or toothing of any other type, and the tooth shape itself may also be of any design, for example with straight flanks or with involute gearing or a spherical tooth shape. Accordingly, the invention is not restricted to toothed elements 1, 2 and drives 3 of the type illustrated in the drawings. In particular, the invention relates to all types of meshing toothed elements 1, 2 for which it is necessary to set a tooth flank clearance 4, as illustrated in FIG. 3, this tooth flank clearance being merely indicated in FIG. 3. Since the concept of a tooth flank clearance 4 forms part of the general knowledge of a skilled person working in the field of mechanical engineering, no further explanation is necessary here.

FIGS. 2 and 3 illustrate the principle on which the invention is based. A polymer coating 5 is applied to at least one of the toothed elements 1, 2 so that the two toothed elements 1, 2 can be assembled without any mutual clearance, i.e. without any gap between them, prior to using the drive 3, for example by moving the toothed element 2 axially parallel with and in the direction towards toothed element 1. Since the coating 5 is abradable, the tooth flank clearance 4, i.e. the gap between the teeth, is created within a short time, as indicated in FIG. 3.

The polymer coating 5 itself may be of a type known from the prior art. Accordingly, it contains a binding agent with at least one filler distributed through it. The binding agent may be organic. The filler is selected from standard fillers such as carbonates and silicates and in this respect, it is preferable to provide at least one solid lubricant as one of the fillers.

In principle, all synthetic resins are suitable as the polymer material, such as those described in patent specification WO 02/48575 A, for example. This polymer material may be selected from a group comprising phenolic resins, amine resins, alkyde resins, polyvinyl acetate, epoxy resins, polyurethane resins, polyester resins, chlorinated polypropylene, ketone resins, acrylate resins, styrene-butadiene copolymers, polyamides, polyimides, polyester imides, polyether imides and polyamide imides or mixtures thereof. A polyamide imide is preferably used as the polymer material. It is also possible to use precursors of these resins, such as poly (carbamoyl carboxylic acid) in the case of polyamide imide.

The solid lubricant may be selected from a group comprising inorganic solid lubricants, such as graphite, MoS₂, boron trioxide, hexagonal BN, WS₂, lead monoxide, basic lead carbonate, red lead and glasses. Given the problems which lead-based materials cause in terms of polluting the environment, it is preferable to use graphite and/or MoS₂. Another possible solid lubricant is particulate polytetrafluoroethylene.

The polymer material may be dissolved or dispersed in an appropriate solvent and the filler, in particular the solid lubricant, is likewise dispersed in this solution or dispersion. Standard dispersing equipment may be used to produce these dispersions.

The solvent may be a standard solvent of the type used for varnishes or solutions or dispersions, such as for example toluene, xylene and other organic hydrocarbons, as well as solvent mixtures, for example the mixtures described in patent specification DE 10 2005 013 867 A containing 2-methyl-2-pentanol-4-one with dimethyl benzene, toluene and N-methylpyrrolidone.

With regard to the particle size of the solid lubricant, it should be pointed out that it may be in the range of between 1 μm and 60 μm, and platelets of MoS₂ may be used in particular, with a platelet size selected from a range with a lower limit of 10 μm×10 μm×0.5 μm and an upper limit of 40 μm×40 μm×5 μm (mean length×mean width×mean height).

As known from the prior art, such coatings are abradable and are so within a short time. By this is meant that this polymer coating 5 is abraded within 240 s, in particular within 60 s, after being placed in services due to the meshing engagement of the toothed elements 1, 2 and the mechanical load to which the polymer coating 5 is subjected. As a result, the polymer materials and solid lubricants which are used in particular are compatible with oil so that once these polymer coatings 5 have been abraded, the particles do not cause problems in the lubricating oil with which the toothed elements 1, 2 are wetted.

FIG. 4 illustrates the process of setting the tooth flank clearance 4 (FIG. 3) between the two mutually meshing toothed elements 1, 2. To this end, the first toothed element 1 to which the polymer coating 5 has been applied is fitted on the drive 3, after which the second toothed element 2 which is not coated with a polymer coating 5 in the embodiment illustrated as an example in FIG. 4 is moved towards the first toothed element 1 with a pre-definable force (arrow 6) so that there is no gap between the teeth 7, 8 of the two toothed elements 1, 2 at least in the tooth flank region, in other words the teeth 7, 8 sit one against the other at least in the tooth flank region of the toothed elements 1, 2.

This assembly corresponds to that already known from the prior art documents mentioned above.

In this embodiment, only one toothed element 1 is provided with the polymer coating 5 and in the embodiment illustrated as an example in FIG. 4, the entire teeth, i.e. the two tooth flanks, namely the front and rear tooth flank, as well as the tooth head and the tooth base, are provided with the polymer coating 5. Within the scope of the invention, however, it is also possible for only the tooth flanks or, for example, only the front or only the rear tooth flank of a toothed element 1 to be provided with the polymer coating. Likewise, it is also possible for both toothed elements 1, 2, i.e. their teeth 7, 8, to be provided with a polymer coating 5 across their full surface, in other words both along the front and rear tooth flanks as well as the tooth head and tooth base, or the two toothed elements 1, 2 are provided with a polymer coating 5 on only the front or rear tooth flank or on the front tooth flank of one of the toothed elements 1, 2 and on the rear tooth flank of the second toothed element.

The desired tooth flank clearance 4 (FIG. 3) is obtained by positioning the second toothed element 2 relative to the first toothed element 1 in this way and due to the abradable polymer coating 5, which is abraded within a short time after running in the drive 3 due to the mechanical stress caused by the meshing teeth 7, 8.

In order to produce the polymer coating 5, the invention proposes a prior treatment by means of plasma, in particular by means of oxygen plasma. This prior treatment, namely activation of the surface of the teeth 7, 8 to which the polymer coating 5 will be applied, is run for a period of between 1 min and 30 min, in particular at a temperature from 40° C. to 70° C. and at a pressure of between 0.2 mbar and 0.7 mbar. In this respect, it is of advantage that this activation does not impart extra roughness to the surface, as is the case in the prior art when using a phosphatisation process, so that a very smooth surface is already obtained, and in particular, the teeth 7, 8 have an arithmetic mean roughness value Ra in accordance with DIN EN ISO 4287 which is selected from a range of 0.2 μm to 3 μm, which means that the polymer coating 5 does not have a high surface roughness which must then be compensated, as known from the prior art, and it is therefore possible to apply very uniform coatings of the polymer coating 5 with a narrow coating thickness tolerance. This makes adjustment of the tooth flank clearance 4 more accurate. Another particular advantage of this is that once the polymer coating 5 has been abraded, there is no rough surface caused by phosphatisation co-operating with the respective other toothed element 1, 2 and causing more extensive abrasion during this running-in phase, and instead, the surfaces are already very flat and result in improved tribology during the running-in phase of this drive 3 already.

A deep cleaning process may optionally be run using an appropriate solvent, especially if the toothed elements 1, 2 are made from sintered material, for example sintered steel or an iron-based sintered material. This means that the pores which are usually incorporated in sintered materials can be cleaned accordingly, enabling the removal of oil residues or lubricant residues used as standard during the process of manufacturing these toothed elements 1, 2, left behind from the pre-treatment of the toothed elements 1, 2, for example lubricants which prevent the toothed elements 1, 2 from seizing in the respective dies or moulds. To this end, the toothed element or elements 1, 2 is or are preferably fed into a chamber which can be evacuated, this chamber is flooded with the respective solvent, for example perchloroethylene, and this solvent is then pumped out again and the chamber evacuated so that the solvent evaporates, simultaneously removing any dirt or oil or lubricant residues adhered to the toothed elements 1, 2. To enhance the cleaning action, this process can be run several times. In addition, the plasma activation of the surface used to increase the surface tension of the toothed elements 1, 2 may also be used as a means of cleaning the surface or for deep cleaning the toothed elements 1, 2, in which case an oxygen plasma or an oxidising plasma is used, because the oil or lubricant residues left behind from the previous processes are usually hydrocarbons and these are split and converted into CO₂ and water.

This pre-treatment proposed by the invention is followed by the process of coating the toothed elements 1, 2 at the intended surface regions, in other words the surfaces of the teeth 7, 8 in particular. This polymer coating 5 may be applied in a manner known from the prior art using conventional methods known in the paint and varnish industry. For example, it is possible to use solvent-free, electrostatic powder coatings but it is also possible for the binding agent, in particular the polymer material, to be dissolved in or dispersed in a solvent and the filler, i.e. solid lubricant, is then added to this solution or dispersion. The toothed elements 1, 2 can then be immersed in this mixture during a dipping process to coat the surface or a centrifugal process or spraying process could be used. Once this solution or dispersion has been applied, the solvent is evaporated by heating, for example, so that the solid material dissolved in it is left behind on the surface. If necessary, the applied mixture containing the polymer material and filler may also be cured, for example by UV radiation or electron beam curing or by raising the temperature.

If necessary, another option is to build up the polymer coating 5 in several individual layers, in other words repeat the coating process several times. The individual part-layers may optionally be cured or hardened in between, although the cohesiveness of the polymer coating 5 is improved if this hardening process is not run to its full conclusion and instead, the surface is still slightly soft. The temperature used to remove the solvent, which may be between 180° C. and 240° C., for example, can also be used to control the degree of cross linking or chain length of the polymer material during curing. The lower the heating temperature is, the more incomplete the curing will be and the easier it will be to remove the polymer coating during running-in, i.e. during the proving trial of the drive 3.

The polymer coating 5 is preferably applied by a spraying process, as in the case of the two embodiments illustrated in FIGS. 5 to 9. FIGS. 5 to 7 illustrate a coating device 9 designed to apply a partial coating to the teeth 7, 8 of the toothed elements 1, 2. By partial is meant that these toothed elements 1, 2 are not provided with the polymer coating 5 around a full 360° and instead are coated within only an angular range of between 0° and 270°. This angular range is not intended to be restrictive and is freely selectable, depending on what is required of the toothed element 1, 2. The individual toothed elements 1, 2 are disposed on a holder device 10. This holder device 10 may be based on a shaft-type design which is inserted through the bores of the toothed elements 1, 2 provided as a means of mounting the toothed elements 1, 2 on the co-operating shafts of the drive 3, and several toothed elements 1, 2 can therefore be placed on this holder device 10 one above the other in a tower arrangement.

However, it should be pointed out that within the scope of the invention, it is naturally also possible to apply individual coatings, i.e. one toothed element 1, 2 is coated during a coating process.

To enable a partial coating to be applied, a part of the toothed element 1, 2, i.e. its surface, is masked with a screen 11, the width of which corresponds to the width of the area which is not be coated.

The holder device 10 is mounted in the coating device 9 so that it is able to rotate and is rotated in the direction indicated by circular arrow 12 during the coating process.

In this embodiment, the coating is applied by a spraying process, for which purpose at least one nozzle 13 is disposed in the vicinity of the holder device 10, i.e. the toothed elements 1, 2, and a spray mist 14 is ejected from this nozzle 13, which emits the dispersion or solution described above in the direction towards the surface of the toothed elements 1, 2. As may be seen from the plan view illustrated in FIGS. 5 and 6, the screen 11 illustrated in FIG. 6 is moved into the region of the spray mist 14 due to the rotation of the toothed elements 1, 2 on the holder device 10 so that in this region, the screen 11 is coated with the spray mist and the surfaces of the toothed elements 1, 2 lying underneath remain free of coating.

The screen 11 may also be attached to the holder device 10, as indicated in FIGS. 5 and 6.

As may be seen from FIG. 7, the spraying device, in particular the nozzle 13, is mounted so that it can be moved vertically in the coating device 9, as indicated by double arrow 15. As a result of this ability to move vertically, it is advantageously possible to place a larger number of toothed elements 1, 2 on the holder device 10 in a tower arrangement, as illustrated in FIG. 7, and coat them simultaneously, thereby reducing the cost of applying this coating and increasing the number of finished products which can be obtained.

The coating device 9 illustrated in FIGS. 8 and 9 essentially corresponds to the embodiment illustrated in FIGS. 5 to 7 except that in this instance no screen 11 is provided for the coating device 9 illustrated in FIGS. 8 and 9 and the polymer coating 5 is therefore applied to the teeth 7, 8 of the toothed elements 1, 2 around a full 360°. Likewise in this embodiment, the toothed elements 1, 2 are held on the holder device 10 so that they are able to rotate and a spraying unit incorporating the nozzle 13 is able to move vertically.

Within the scope of the invention, it is not necessary for the spraying unit to move vertically. It might be that it is only the holder device 10 which rotates for the coating process.

The rotation speed of the holder device 10 for the toothed elements 1, 2 in both embodiments may be selected from a range with a lower limit of 60 revolutions/min and an upper limit of 120 revolutions/min, for example 90 revolutions/min.

The advantage of 360° coating compared with partial coating is that there is no need to apply positioning markers on the toothed elements 1, 2, which means that when assembling the drive 3, i.e. positioning the toothed elements 1, 2, there is no need to pay attention to positioning markers and these toothed elements 1, 2 can be fitted in any position relative to one another. This makes assembly easier for the fitter on the one hand and also lends itself to a higher degree of automation without the need for separate position-marking devices on the other hand.

### EXAMPLE OF AN EMBODIMENT

The starting material was a gear made from a sintered steel, with a core density in the range of between 6.8 g/cm³ and 7.6 g/cm³, which was additionally surface compacted so that the regions close to the surface have a higher density than the core density. The porosity of the toothed element 1 in this instance was 5%.

This gear was then subjected to a cleaning process with perchloroethylene at a temperature of ca. 105° C. and a pressure in the vacuum chamber of 4 mbar whilst the solvent was being evaporated.

The deep cleaning process was repeated five times and the dried gear was then transferred to a plasma treatment unit. It was operated using an oxygen plasma in which the proportion of oxygen in the plasma gas was 99.99%. The temperature during the plasma treatment was 60° C. and the pressure 0.4 mbar, and an alternating voltage with a frequency of 2.45 GHz was used.

The plasma treatment was run for a period of 5 min.

A coating of polyamide imide containing MoS₂ as the solid lubricant was then applied in a spraying operation based on the embodiment illustrated in FIGS. 8 and 9, but in this instance only a single coating was applied to a single gear. The proportion of polyamide imide in this polymer coating 5 was between 30% by weight and 70% by weight and that of the solid lubricant was between 70% by weight and 30% by weight. The solvent used was N-methyl pyrrolidone and the proportion of solvent by reference to the solid substance was 60% by volume.

After removing, i.e. evaporating, the solvent from the polymer coating 5, this polymer coating 5 was dried and hardened at a temperature of between 70° C. and 90° C.

FIG. 10 illustrates a detail of the coated surface of the gear in the region of the tooth 7. This image was taken using a microscope with a magnification factor of 500:1. As illustrated very clearly in FIG. 10, the coating thickness is between 18 μm and 21 μm, and therefore has a significantly narrower coating thickness tolerance than that described in the prior art documents.

As also clearly illustrated in FIG. 10, the polymer coating 5 is applied directly to the surface of the tooth 7, i.e. without applying coatings of primer in between, in particular phosphatisation coatings.

Coating thicknesses in the range of between 1 μm and 300 μm can be produced by the method proposed by the invention, depending on what coating thickness of the polymer coating 5 is required for producing the desired tooth flank clearance 4.

The embodiments illustrated as examples represent possible variants of the coating method, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the coating device 10 and toothed elements 1, 2, they and their constituent parts are illustrated to a certain extent out of scale and/or on an enlarged scale and/or on a reduced scale.

Above all, the individual embodiments of the subject matter illustrated in FIGS. 1, 2, 3; 4; 5, 6, 7; 8, 9; 10 constitute independent solutions proposed by the invention in their own right. The objectives and associated solutions proposed by the invention may be found in the detailed descriptions of these drawings.

### LIST OF REFERENCE NUMBERS

1 Toothed element
2 Toothed element
3 Drive
4 Tooth flank clearance
5 Polymer coating
6 Arrow
7 Tooth
8 Tooth
9 Coating device
10 Holder device
   11 Screen
12 Circular arrow
13 Nozzle
14 Spray mist
15 Double arrow

1. Method of producing an abradable polymer coating (5), optionally containing at least one solid lubricant, on a surface of teeth (7, 8) of a metal toothed element (1, 2) for setting a tooth flank clearance (4) between the teeth (7, 8) of two meshing toothed elements (7, 8), whereby the abradable polymer coating (5) is applied to at least part of a surface of the teeth (7) of at least one toothed element (7, 8), wherein the surface to be coated is treated in a plasma prior to applying the polymer coating (5) and the polymer coating (5) is applied directly to this surface.

2. Method as claimed in claim 1, wherein the plasma used is an oxygen plasma.

3. Method as claimed in claim 1, wherein the plasma treatment is conducted at a temperature selected from a range with a lower limit of 40° C. and an upper limit of 100° C.

4. Method as claimed in claim 1, wherein the plasma treatment is conducted at a pressure selected from a range with a lower limit of 0.01 mbar and an upper limit of 200 mbar.

5. Method as claimed in claim 1, wherein the surface tension of the metal surface of the toothed element (1, 2) is increased by at least 30% compared with the surface tension prior to the treatment and a toothed element is used, the surface tension of which is at least 40 mN/m in the region to be coated.

6. Method as claimed in claim 1, wherein the plasma treatment is conducted at an alternating voltage with a frequency selected from a range with a lower limit of 10 kHz and an upper limit of 3 GHz.

7. Method as claimed in claim 1, wherein the surface to be coated is subjected to at least a one-off cleaning process with an oil-dissolving cleaning agent prior to being treated with plasma.

8. Method as claimed in claim 7, wherein the cleaning process is conducted partially under vacuum.

9. Method as claimed in claim 7, wherein perchloroethylene is used as the cleaning agent.

10. Method as claimed in claim 1, wherein the coating is applied to a toothed element (1, 2) produced by sintering.

11. Metal toothed element (1) with a main body with teeth (7) along its circumference, which has an abradable polymer coating (5) on at least part of a surface, wherein the polymer coating (5) is applied directly to the metal surface.

12. Toothed element (1) as claimed in claim 11, wherein the main body is a sintered component.

13. Toothed element as claimed in claim 12, wherein the main body has a porosity, at least in regions close to the surface, selected from a range with a lower limit of 0.1% and an upper limit of 20%.

14. Drive (3) with at least two meshing toothed elements (1, 2), wherein at least one toothed element (1, 2) is as claimed in claim 11.
